(19) United States
(12) Patent Application Publication
(10) Pub. No.: US 2017/0236084 A1
(43) Pub. Date: Aug. 17, 2017

(54) SYSTEM AND METHODS FOR IMPLEMENTING CUSTOM TRANSACTIONS WITHIN A MULTI-TENANT PLATFORM

(71) Applicant: NetSuite Inc., San Mateo, CA (US)

(72) Inventors: Craig Sullivan, Kingsburg, CA (US); Stephen Clode, San Jose, CA (US)

(21) Appl. No.: 14/567,822

(22) Filed: Dec. 11, 2014

Related U.S. Application Data
(60) Provisional application No. 61/915,061, filed on Dec. 12, 2013.

(51) Int. Cl. G06Q 10/06; H04L 29/08

(52) U.S. Cl. CPC G06Q 10/06316; H04L 67/10

(57) ABSTRACT

Systems and methods for enabling a user of a multi-tenant, cloud-based, business-data-processing platform to define one or more custom transactions. Custom transactions provide the power and flexibility for an enterprise resource planning (ERP) system to satisfy varying requirements of national/international markets that have and often require additional transaction types to cover aspects of business activity that have an ERP impact. The systems and methods directed to custom transactions provide a mechanism by which a multi-tenant, business-data-processing platform's core ERP functions and workflow can be extended in a seamless, scalable, sustainable manner to address vertical, international compliance, or customer-specific needs, while maintaining ERP integrity and a business document approach to transactions. Such a capability is one aspect of delivering a multi-tenant, cloud-based ERP functionality that allows businesses to tailor the implementation to meet individual needs while retaining seamless features of the platform, such as upgrade capability, high performance, access control, and reporting.

### PRIORITY CLAIM

This application claims the benefit of U.S. Provisional Application No. 61/915,061, entitled “System and Methods for Implementing Custom Transactions within a Multi-Tenant Platform,” filed Dec. 12, 2013, which is incorporated by reference in its entirety herein for all purposes.

### BACKGROUND

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, and web-based customer support, as well as reporting and analysis capabilities relating to these functions. With differing levels of overlap with ERP/CRM initiatives and with each other, efforts have also been directed toward development of increasingly integrated partner and vendor management systems, web store/eCommerce systems, product lifecycle management (PLM) systems, and supply chain management (SCM) systems.

Traditionally, ERP systems—including modern Cloud-based ones—provide a defined set of transaction types based on the scope of the application intended by the developer. These defined transaction types may span typical, generic business processes, such as: Vendor Bills, Customer Invoices, Inbound and Outbound Payments, General Ledger (GL) Journals, as well as Industry/Vertical-specific transaction types, such as Revenue Recognition Journals or Inventory Adjustments. However, the diversity of businesses' operational requirements and the needs of vertical or company-specific workflows are typically not well served by such a predetermined and limited approach.

For example, the financial, tax, revenue recognition, or other impacts of an event may differ depending on the jurisdiction in which the event occurred, the state of a company at the time of the event, the external rules applicable to the company, and the like. A company may also have its own internal processes that require specific ways of tracking revenue generating events in order to properly account for the impact of those events on the company's other functions or operations. These might include, for example, a process to trigger an inventory maintenance or sales representative recognition process based on one or more events or characteristics of an event.

With conventional ERP systems, specific internal processes or situations are often handled by end users building out a Workflow, or by third party developers building add-ons or other forms of increased functionality. This approach can provide a standard GL Journal tracking the Accounting impact of an event, but such an approach ignores the need to identify the transactions for searching/reporting in a specific context, allocating type-specific transaction number sequences, controlling access to only those users with the appropriate permissions, and enabling the transactions that are the subject of the customized aspects to be utilized more fully with the other capabilities of an entire ERP/CRM system or integrated business data processing platform. In some cases, third party developers have been provided access to the core application code so that they can make customer- or industry-specific changes, thereby enabling them to develop type-specific transactions. But, such efforts require deep knowledge of the code-base and development architecture, as well as software development skills and processes. These are things that are often out of the reach of smaller development teams with limited resources and little experience in handling the high volume and reliability needs of large enterprises. Further, customizations and/or core code changes that are made to support additional functionality in a traditional on-premise (as opposed to cloud-based) platform are a fundamental reason why businesses deploying those systems end up with version lock challenges—it is impossible for the ERP system vendor to know what their customers have done to each deployment of the system when they have the ability to modify the core code in-house.

### SUMMARY

Embodiments covered by this patent are defined by the claims and not by this summary. This summary is a high-level overview of various aspects of the subject matter disclosed herein and introduces some of the concepts that are further described in the Detailed Description section below. This summary is not intended to identify key or essential features of the disclosed subject matter, nor is it intended to be used in isolation to determine the scope of the claimed subject matter. The subject matter should be understood by reference to appropriate portions of the entire specification of this patent, to any or all drawings, and to each claim.

Embodiments are directed to systems, apparatuses, and methods for enabling a user of a multi-tenant, cloud-based, business-data-processing platform to define one or more “custom transactions”. In one embodiment, such custom transactions provide the power and flexibility for an ERP module of the platform to satisfy the varying requirements of national/international markets that have and often require additional transaction types to cover aspects of their business activity that have an ERP and/or GL impact, and which have not been supported or anticipated by a developer in the first instance.

The systems and methods directed to custom transactions provide a method by which a multi-tenant, business-data-processing platform's core ERP functions (and if desired, others as well) and workflow can be extended in a seamless, scalable, sustainable manner to address vertical, international compliance, or customer-specific needs, while maintaining GL integrity and a business document approach to GL transactions. Such a capability is one aspect of delivering a multi-tenant, cloud-based ERP functionality that allows businesses to tailor the implementation to meet their individual needs while retaining the seamless features of the platform, such as upgrade capability, high performance, access control, reporting, and availability characteristics.

Other objects and advantages will be apparent to one of ordinary skill in the art upon review of the detailed description and the included figures.

### BRIEF DESCRIPTION OF THE DRAWINGS

Embodiments in accordance with the present disclosure will be described with reference to the drawings, in which:

FIG. 1 is a diagram illustrating elements or components of an example operating environment in which an embodiment may be implemented;

FIG. 2 is a diagram illustrating additional details of the elements or components of the multi-tenant distributed computing service platform of FIG. 1, in which an embodiment may be implemented;

FIG. 3 is a flow chart or flow diagram illustrating a process, method, operation, or function for permitting a user to define and execute a custom transaction that may be used when implementing an embodiment;

FIG. 4 shows a graphical user interface for prompting and acquiring input from a user during custom transaction according to an embodiment. and

FIG. 5 is a diagram illustrating elements or components that may be present in a computer device or system configured to implement a method, process, function, or operation in accordance with an embodiment.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present embodiments may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, or the like) that is part of a client device, server, or other form of computing device and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

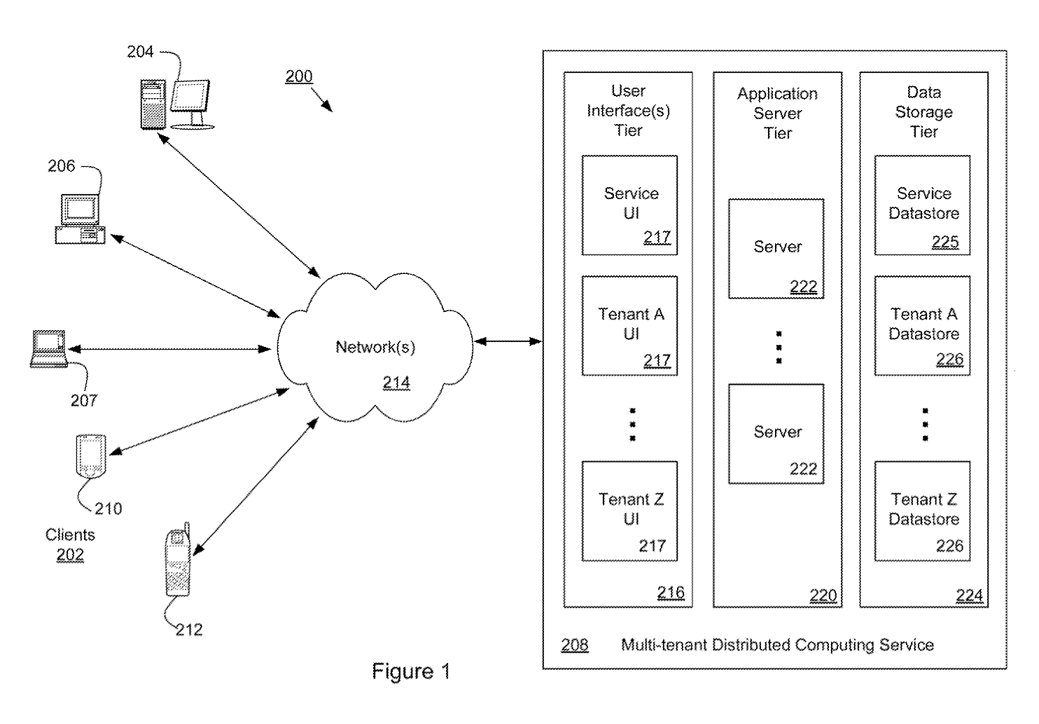

Embodiments are directed to systems, apparatuses, and methods for enabling a user of a multi-tenant data processing platform to extend the capabilities of the platform in order to satisfy operational, jurisdictional, or other requirements with regards to the impact of an event on financial, accounting, inventory, or other business functions. In one embodiment, a user is enabled to define and execute a “custom transaction” in order to permit the processing of the event in a way that takes into account specific jurisdictional or other requirements with regards to how revenue is recognized, taxes are calculated, inventory is reported, etc. The custom transactions may be defined by a user without the need to make changes to the underlying code base for the platform, and can be utilized with other desirable functional capabilities of the platform (e.g., access control, reporting, integration with other functional modules, and the like). These and other aspects of the subject matter are described further below with respect to FIGS. 1-4.

FIG. 1 is a diagram illustrating elements or components of an example operating environment in which an embodiment may be implemented. Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

In some embodiments, the subject matter disclosed herein may be implemented in the context of a multi-tenant, “cloud” based environment, typically used to develop and provide web services for end users. Note that embodiments may also be implemented in the context of other computing or operational environments or systems, such as for an individual business data processing system, a remote or on-site data processing system, other form of client-server architecture, and the like.

In FIG. 1, an example operating environment 200 includes a variety of clients 202 incorporating and/or incorporated into a variety of computing devices that may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business-data-processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, and the like. Each processing tier shown in FIG. 1 may be implemented with a set of computers and/or computer components including computer servers and processors, and may perform various functions, methods, processes, or operations as determined by the execution of a software application or set of instructions. The data storage tier 224 may include one or more data stores, which may include a service data store 225 and one or more tenant data stores 226.

Each tenant data store 226 may contain tenant-specific data that is used as part of providing a range of tenant-specific business services or functions, including but not limited to ERP, CRM, eCommerce, Human Resources management, payroll, and the like. Data stores may be implemented with any suitable data storage technology, including structured query language (SQL) based relational database management systems (RDBMS).

In accordance with one embodiment, the distributed computing service/platform 208 may be a multi-tenant and service platform 208 and may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an ERP system that integrates the capabilities of several historically separate business computing systems into a common system, with the intention of streamlining business processes and increasing efficiencies on a business-wide level. By way of non-limiting example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of a service platform is an integrated CRM system, which is designed to assist in obtaining a better understanding of customers, enhance service to existing customers, and assist in acquiring new and profitable customers. By way of non-limiting example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system (such as element 208 of FIG. 1) may also include one or more of an integrated partner and vendor management system, eCommerce system (e.g., a virtual storefront application or platform), product lifecycle management (PLM) system, human resources management system (which may include medical/dental insurance administration, payroll, and the like), or supply chain management (SCM) system.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, and the like. A web server is a most often a combination of hardware and the software that helps deliver content (typically by hosting a website) to client web browsers that access the web server via the Internet.

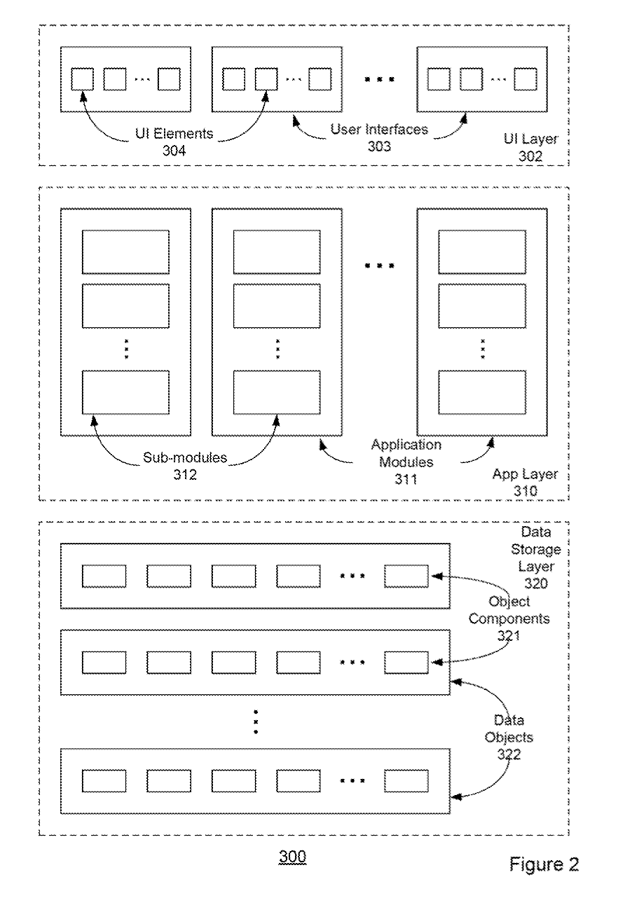

Rather than build and maintain such an integrated business system themselves, a business may utilize systems provided by a third party. Such a third party may implement an integrated business system as described above in the context of a multi-tenant platform, wherein individual instantiations of a single comprehensive integrated business system are provided to a variety of tenants. However, one challenge in such multi-tenant platforms is the ability for each tenant to tailor their instantiation of the integrated business system to their specific business needs. In one embodiment, this limitation may be addressed by abstracting the modifications away from the codebase and instead supporting such increased functionality through custom transactions as part of the application itself. Prior to discussing additional aspects of custom transactions, additional aspects of the various computing systems and platforms are discussed next with respect to FIG. 2.

FIG. 2 is a diagram illustrating additional details of the elements or components of the distributed computing service platform of FIG. 1, in which an embodiment may be implemented. The software architecture depicted in FIG. 2 represents an example of a complex software system to which an embodiment may be applied. In general, an embodiment may be applied to any set of software instructions embodied in one or more non-transitory, computer-readable media that are designed to be executed by a suitably programmed processing element (such as a CPU, microprocessor, processor, controller, computing device, and the like). In a complex system such instructions are typically arranged into “modules” with each such module performing a specific task, process, function, or operation. The entire set of modules may be controlled or coordinated in their operation by an operating system (OS) or other form of organizational platform.

In FIG. 2, various elements or components 300 of the multi-tenant distributed computing service platform of FIG. 1 are shown, in which an embodiment may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module. Such function, method, process, or operation may include those used to implement one or more aspects of the system and methods, such as one or more functions to enable a user to identify a need for a custom transaction, define a custom transaction, to set parameters for the custom transaction, to execute the custom transaction when relevant, and to update any number of modules including the previously maintained process and user-defined processes.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 1) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-2 are not intended to be limiting examples. Alternatively, or in addition, computing environments in which embodiments may be implemented include any suitable system that permits users to access, process, and utilize data stored in a data storage element (e.g., a database) that can be accessed remotely over a network. Although further examples below may reference the example computing environment depicted in FIGS. 1-2, it will be apparent to one of skill in the art that the examples may be adapted for alternate computing devices, systems, and environments.

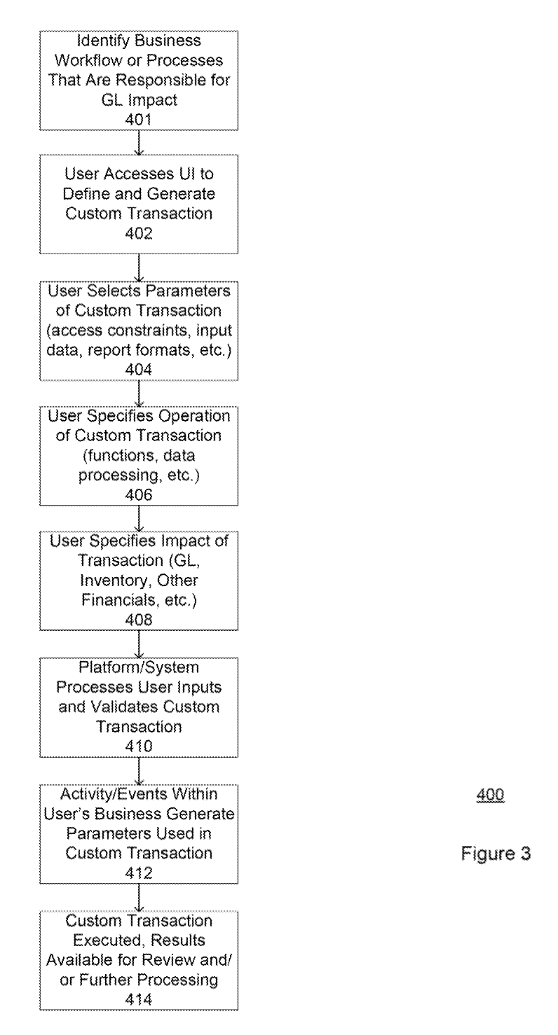

In general, the computing environments of FIGS. 1-2 provide a cloud-based computing environment in which an end user of an ERP system may access functionality for defining a custom transaction for a specific transaction type that may be unique to the end-user. That is, a typical deployment of an ERP system may include a great number of common transaction types (e.g., a computer-implemented procedure for manipulating data accordingly when a transaction is invoked—referred to as transaction type hereinafter), such as vendor billing, customer invoicing, and others that have previously been noted. Such common transaction types, as part of the ERP system, are seamlessly integrated with respect to a large number of transaction parameters. Each common transaction type may be subject to specific transaction parameters. For example, all transaction types may be recorded in a GL such that all transactions, as they are entered, are searchable and available through a GL record. Further, by keeping all transaction, regardless of type in the GL, a unique and orderly sequence number may be assigned to each transaction as it is entered. Thus, having all transactions entered into the GL with a next-in-line sequence number are global transaction parameters for all transaction types. As an end-user wishes to create a custom transaction (i.e., a transaction type that is not part of the “out-of-the-box” deployment of the ERP system, the computer-implemented method described with respect to the flow chart of FIG. 3 ensures that certain transaction parameters are maintained with respect to the overall ERP system.

FIG. 3 is a flow chart or flow diagram illustrating a process, method, operation, or function 400 for permitting a user (in this example, an end-user) to define and execute a custom transaction that may be used when implementing an embodiment. Further, a previously created custom transaction may also be modified changed or copied using a similar method by the initial user or other users once the custom transaction is deployed for use. As shown in FIG. 3, in one embodiment, a user wishing to define a custom transaction accesses a user interface (UI) or coding process (e.g., a script editor) that assists in identifying those business processes or workflows (i.e., transaction parameters) that may impact a general ledger (GL) (step 401) or other aspects of the ERP system. This assists a user to be made aware of what internal processes or operations are occurring that may impact the GL and hence should be considered as a potential “custom transaction”. The user is then provided with a UI or scripting process that is configured to enable the user to define and generate a desired custom transaction (step 402). As part of defining the custom transaction, the user may select or code transaction parameters (such as variables, exceptions, characteristics, terms, and the like) that apply to the custom transaction (step 404). These may include such specific transaction parameter attributes such as the categories, fields, data types, data names, or other data input characteristics for the data that will be used in implementing the definition of the custom transaction. The transaction parameters may also include user definition of the access control for the custom transaction (which may be expressed in terms of the role of the persons who are able to access the results of custom transaction), data reporting formats, and the like.

Next the user defines or otherwise specifies the specific operation of the custom transaction (step 406). This may include defining the way in which the custom transaction will operate on the data inputs, the data processing operations that will be applied, the flow of the calculations, and the like. Then, the user specifies the impact of the custom transaction (step 408). This may be done as part of step 406 or as a separate step. The impact may be defined in terms of where the results of one or more calculations implemented in step 406 are recorded or input to another function. For example, a specific calculation performed in step 406 may then be used as an input to a function or operation in another module (such as CRM, eCommerce, etc.).

As the user assembles the specific transaction parameters (collectively in steps 402, 404, 406, and 408) that will define the custom transaction, it is apparent that the combination of chosen transaction parameters to set will necessarily be different from any other transaction type already defined by the “out-of-the-box” instantiation of the ERP system; hence the reason why such a user defined transaction type is “custom.”

After defining the operation and impact of the custom transaction (i.e., the transaction parameters), the user submits the new custom transaction to the system/platform for storage at a server-side data store. The multi-tenant business data processing platform processes the specific transaction parameters for the defined custom transaction and validates it (step 410). This may involve performing one or more checks or evaluations to ensure that the custom transaction is properly defined and can be safely executed. Once stored at the server-side data store, the custom transaction may be invoked by the user or any other user having credentials (e.g., as authenticated through a credential module) associated with the business entity of the creating user. The custom transaction is now ‘native’ to the business entity's instantiation of the ERP system allowing other users to invoke, manipulate, delete or otherwise modify the newly created custom transaction since it is stored with all other ‘out-of-the-box’ transactions types.

At some later time, one or more activities or events occur within the user's business that generates the set of inputs used in the custom transaction (step 412). This may involve a sale, receipt of a shipment into inventory, recognition of revenue, and the like. In response, the custom transaction is executed (step 414), and the results are available for review and/or further processing.

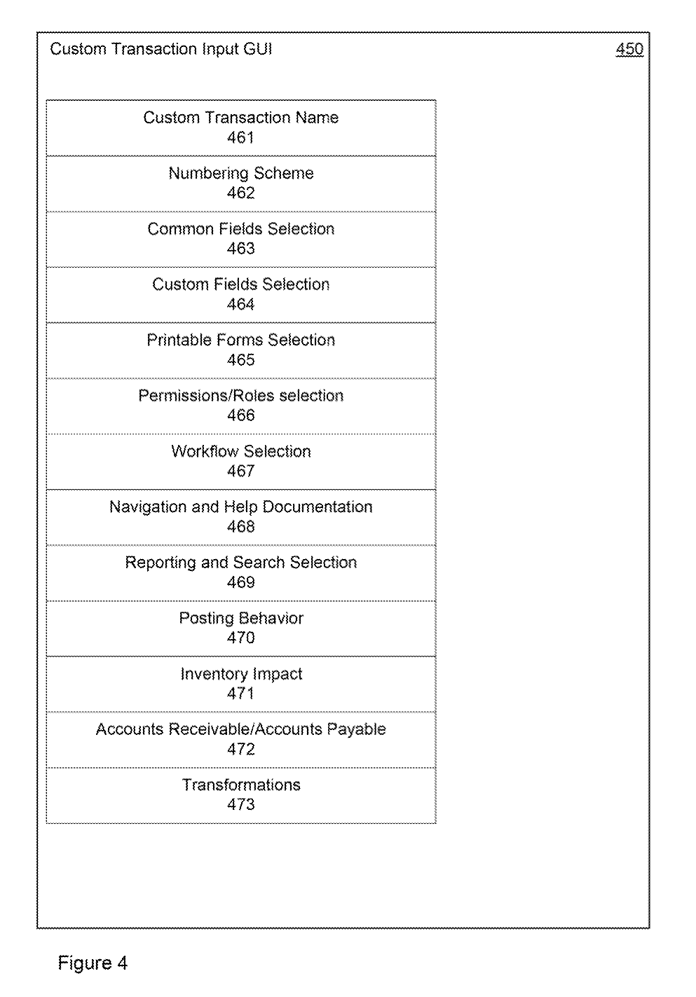

The method as shown in the flow chart of FIG. 3 represents a generalized flow of steps that a user may follow to create or modify a custom transaction within the context of an ERP system. A skilled artisan understand that the steps described with respect to FIG. 3 may be representative of computer-executable instructions for facilitating the input of data from the user at a client computer associated with the user via a user interface, such as a graphical user interface as described next with respect to FIG. 4.

FIG. 4 shows a graphical user interface for prompting and acquiring input from a user during custom transaction according to an embodiment. In this GUI 450, each step described above with respect to FIG. 3 may be associated with one or more query boxes in a display configured to receive typed or spoken input from the user. In other embodiments, each query box may be associated with a drop-down menu of choices for a user to select. Alternatively, each query box may further represent a script editor allowing an experienced user to enter code directly to the custom transaction. Thus, the combination of inputs at each query box results in a grouping of transaction parameters that may be used to define a specific custom transaction as created in a simply point-and-click manner by a user. Further, the custom transaction may be associated with a custom transaction name entered by the user and then stored in a data store associated with the user or the user's enterprise. Such a data store may be at a local client to be accessed when the ERP system is instantiated or may be a data store associated with a server computer that is associated the ERP system itself (as generally described in the computing environment of FIGS. 1-2) such that the data store also stores all other defined transactions in addition to the custom transaction.

In the GUI 450, a number of query boxes are presented to a user when defining a new custom transaction. A first one may be a custom transaction name query box 461. In query boxes that follow, several additional transaction parameters may be defined or chosen by the user including:

Transaction Numbering Scheme 462 that may enable a specific manner of transaction numbering on a per custom transaction type basis that remains consistent with the implementation of core transactions type (both with respect to transaction number and with gapless GL numbering).

Common Fields Selection 463 that allows a user to choose commonly used form fields such as date, created by, description/purpose and the like.

Custom Fields Selection 464 that allows a user to define new custom fields such as country or region for tax impact, manager notification, or any other manner of a form field that is not one of the common fields available and provided in the Common Fields Selection 463.

Printable Forms Selection 465 that allows a user to choose specific forms that are to be printed each time the custom transaction is implemented.

Roles and Permissions Selection 466 that allows a user to define specific permissions of what personnel may be allowed to invoke or modify the custom transaction. This may further define what personal receive notifications when such a custom transaction is invoked or modified. Further yet, specific roles may be defined such as managerial approval required by specific personnel.

Workflow Selection 467 allows a user to define custom approval of workflow based on impacted departments and currency value thresholds. This may impact a standard business workflow and identify peer transactions from which the custom transaction may be based. Further, workflow relationships to other transaction types, including ability to initiate workflows or be incorporated into existing standard workflows is provided here. This may include field mapping between one or more peer transactions and the custom transaction, and from the custom transaction to the fields in the next transaction type or process in the workflow.

Navigation and Help Selection 468 allows a user to determine how and where navigation and help aspects interact with the new custom transaction. For example, each custom transaction may be associated with a new own entry in the navigation menus for the application and associated with new help documentation published seamlessly within the primary help system.

Reporting and Search Selection 469 allows a user to incorporate reporting procedures, search parameters, key performance indicators, and the like, through simple configuration and selection through invocation of standard user interfaces for these application areas.

Posting Behavior 470 provides a query box for the user to define specific posting behavior with respect to accounts such as the general ledger or other ledgers. The user may define debits and credits and indicate of such debits and credits must total to zero upon entry. Here a user may further define posting behaviors that may initialize or impact subsequent transactions in the workflow, e.g., whether the custom transaction postings is reversed and replaced by the subsequent transaction, whether the custom transaction posting modifies the postings in the subsequent transaction as opposed to a related standard transaction type, and whether subsequent transaction's workflow is modified as a result of the custom transaction occurring earlier in the workflow.

Inventory Impact 471 allows a user to define how the custom transaction interacts with inventory. For example, whether or not the custom transaction even has the ability to impact Inventory through exposure of an Item Machine API. Such an option allows a user to define, for example, a ‘simple invoice’ with reduced overhead as compared to a core product invoice record.

Accounts Receivable and Account Payable Handling 472 allows a user to define the custom transaction as an AP/AR and cash-basis/accrual basis transaction and be included in the core workflows and reporting capabilities consistent with those business functions as supported by the ERP system.

Transformations 473 allows a user to transform an existing core transaction record to a custom transaction record as well as an existing custom transaction record to a core transaction record. Further, a user may transform a custom transaction record having a custom transaction type to another transaction type (e.g., consider the model of Opportunity->Quote->Sales Order).

Together, these custom transaction parameters when used to define a custom transaction by the user provide native support in the ERP system for custom transactions. That is, a base ERP system is able to function without interference or understanding of the custom workflows represented by the custom transactions. This is advantageous in multi-tenant SaaS (cloud) systems whose margins depend on the economies of scale possible by having a single codebase and being able to upgrade the system at will, without concern that customizations will be impacted. These and other features are advantageous over conventional systems that do not provide point-and-click based configuration or enhancement/update of new custom transaction types (and their associated workflow and GL impacts) by end users. Rather, such conventional ERP systems are built and deployed by developer resources, lack flexibility and require re-implementation as part of a system upgrade. That is, conventional ERP systems contribute to version lock as any customizations impact the ability to upgrade. Such conventional systems also pose a particular challenge in the case of solutions implemented to meet local statutory requirements that could change over time and with minimal notice. Custom transaction implemented with the flexibility described herein enables an internal development team to accelerate vertical and localization efforts by providing a ‘pluggable’ capability that is fundamentally part of a core product but which provides an opportunity to define very specific business processes and workflows without the overhead that comes along with some of the pre-defined business workflows that exist as standard, e.g., Opportunity->Quote->Sales Order->Invoice. Existing functional modules such as recurring billing and fixed assets may benefit by providing more powerful reporting, audit trail and permissions controls by default without explicit coding efforts and while still maintaining upgradability.

Additionally, conventional ERP systems with custom transaction support may leverage only the generic GL Journal transaction record at the completion of a specific business workflow, thereby limiting the ability for subsequent searching/reporting filtering on the specific transaction types and control of access by transaction type-based roles and permissions allocations. Having native custom transaction support as described above, the ERP vendor itself is unaware of the different uses of the generic GL Journal transaction in their application and is therefore unable to properly predict and test customization scenarios proactively for their customers. Further, the custom transactions approach brings material benefits to the developer and user in that standard ‘infrastructure’ (testing, scalability, performance monitoring, and the like) of the ERP system is applied by default while providing the flexibility the end user needs in meeting the unique aspects of the end user's business.

Further yet, in the context of an integrated business suite, GL impacting events can be inferred from business activities that would typically occur outside of the purview of the ERP/financial accounting system. For example, having custom transactions supported in a native manner, purchase requests managed in a procurement system may be marked for accrual purposes and have a custom transaction type called ‘procurement accrual’ created to capture the future obligations (which can then be routed for approval to the appropriate authorizers based on the type and subsequently be submitted for inclusion as part of a financial period end process). Similarly, payroll activities tracked in a separate system might be integrated into the accounting system of record with a specific ‘payroll transaction’ custom transaction type, with permissions controlled by reference to the transaction type to ensure that only certain users can see the details therein.

In yet another advantage, custom transactions shield both the vendor of the financial software and end users from the inherent risks associated with tampering with core application code. This enables the implementer to take advantage of other core system capabilities by default and with ease, speeds up the implementation effort, and reduces the overhead and ongoing burden of the approach that is required in traditional systems. In the context of a multi-tenant, cloud-based system it is not practical to expose the core application code for low level modification by end users; doing so would, in essence, make that particular instance of the application a single-tenant environment. As such, a practical way to support such customization of the ERP and accounting system in a multi-tenant environment is to make custom transactions natively available that allows such customer-specific modifications while protecting the rest of the customer base and the application vendor themselves from the broad ramifications of such changes.

As will become more apparent with respect the following paragraphs of example custom transactions, each custom transaction may be an end result of a cross-functional workflow initiated in what is traditionally a CRM function (e.g., Opportunity->Quote->Sales Order->Fulfillment->Invoice), as a standalone transaction entered by a user, or as another form of workflow. Thus, as a first example, a user may wish to create a ‘payroll journal’ using a custom transaction. The generation of a payroll run may often be handled in a separate and unrelated payroll system that has its own business and approvals process in the context of ensuring that data that feeds into calculations are reviewed and accurate. The subsequent financial impact of the payroll run on the GL in the ERP system is based upon the creation of a GL journal that sums the costs by department, location, etc., so that it can be reflected appropriately in the chart of accounts structure. However, the act of submitting a GL journal to the ERP system can require additional approvals and verification before final posting.

By using a custom transaction type, payroll journal, the ERP system can incorporate a specific workflow and notifications associated with the payroll journal to ensure the appropriate reviews, verifications and approvals are performed (and an audit trail of such kept for future reference/audits/etc.) that are triggered upon the initial creation of each payroll journal transaction. In creating this example custom transaction, a user may define the custom transaction name and additional transaction parameters such as transaction numbering sequence that would begin with the prefix ‘PJ’ and start at transaction number 0001; add common fields such as date, created by, description of purpose (e.g., ‘Payroll for June 2013’), etc.; a custom field to enable selection of a department on each payroll journal transaction line; specify that the custom transaction must be in balance (debits and credits would total zero) before submission; define which roles have the ability to create, view, edit, or delete the payroll journal; define the approval workflow such as approval by a manager, heads of the impacted departments, and other multiple levels of approval; and define additional behaviors such as a balancing entry for the payroll journal that posts to a payroll control account in the GL.

The result of this example implementation is that there is now a specific transaction type for capturing payroll journal information that can be accessed only by those users with the appropriate permissions and which can be reported, searched, and operated on distinctly from other transaction type in the ERP system.

As a second example, a user may wish to create a ‘specific country’ transaction using a custom transaction. Defining and using a custom transaction may be useful in this context of a cross-functional workflow is in relation to tax postings as a result of fulfilling goods in advance of an invoice being created (this may be a requirement in some countries and might be appended to a fulfillment step in the workflow). Thus, a user may create a custom transaction with said name and then define the specific transaction parameters that take into account the specific country requirement for tax postings.

As another example, in the context of a business suite, business processes taking place in other departments can be integrated with the financials kept in the ERP system using custom transactions. For example, the consummation of an agreement with a vendor may have an associated financial impact related to future liabilities during the life of the agreement. Through the definition of a ‘future liability’ custom transaction and the creation of an associated workflow tied to the submission of an agreement approval record, any GL postings are posted in accordance with generally accepted accounting principles (GAAP). The subsequent execution of the agreement could similarly have a further GL impact that can be captured, reviewed and posted in a custom transaction and, thereby, be fully trackable and auditable in the ERP system.

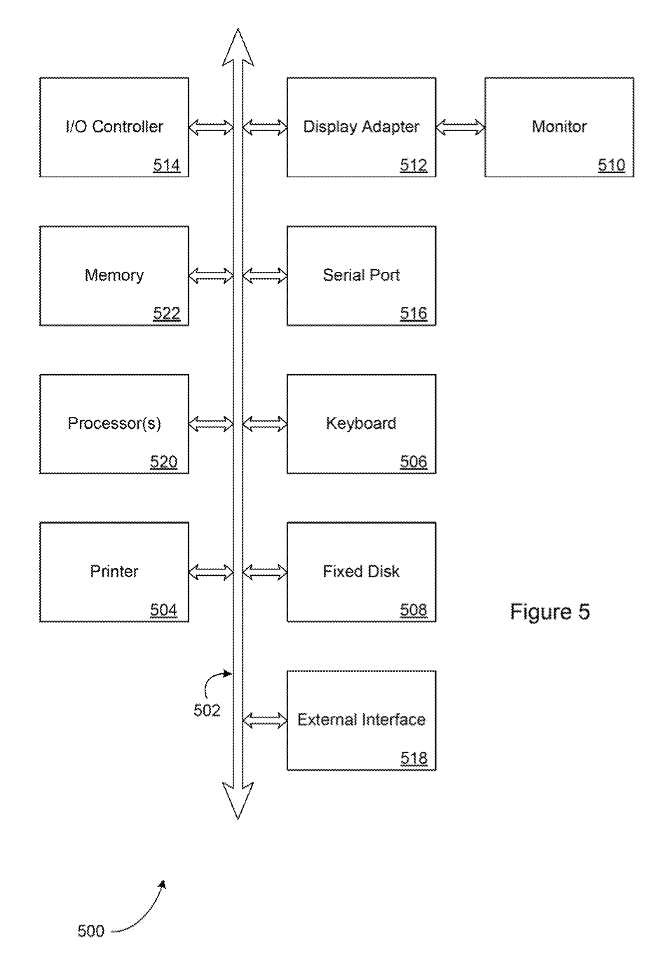

In accordance with one embodiment, the system, apparatus, methods, processes, functions, and/or operations for defining and executing a custom transaction for a user of a cloud-computing platform may be wholly or partially implemented in the form of a set of instructions executed by one or more programmed computer processors such as a CPU or microprocessor. Such processors may be incorporated in an apparatus, server, client or other computing device operated by, or in communication with, other components of the system. As an example, FIG. 4 is a diagram illustrating elements or components that may be present in a computer device or system 500 configured to implement a method, process, function, or operation in accordance with an embodiment. The subsystems shown in FIG. 4 are interconnected via a system bus 502. Additional subsystems include a printer 504, a keyboard 506, a fixed disk 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 5 including a wide area network such as the Internet, a mouse input device, and/or a scanner. The interconnection via the system bus 502 allows one or more processors 520 to communicate with each subsystem and to control the execution of instructions that may be stored in a system memory 522 and/or the fixed disk 508, as well as the exchange of information between subsystems. The system memory 522 and/or the fixed disk 508 may embody a tangible computer-readable medium.

It should be understood that the present disclosures as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

What is claimed is:

1. A computer-implemented method, comprising:
in an enterprise resource planning computing environment, storing a plurality of transaction data manipulation procedures in a data store, each of the plurality of transaction data manipulation procedures respectively associated with a transaction type;
receiving an input from a user of the enterprise resource planning computing environment, the input defining a custom transaction data manipulation procedure that is different from each of the plurality of transaction data manipulation procedures, the custom transaction data manipulation procedure associated with a custom transaction type; and
storing the custom transaction data manipulation procedure in the data store.

2. The computer-implemented method of claim 1, wherein the custom transaction data manipulation procedure further comprises at least one transaction parameter set in accordance with the input.

3. The computer-implemented method of claim 2, wherein the at least one transaction parameter comprises one of the group including: assigning a transaction number, assigning a date, assigning a creator, manipulating data in a general ledger, initiating notification to government agency, initiating notification to a manager, requesting approval from a manager, initiating printing of a form, affecting workflow of a different transaction, populating a help menu; populating a navigation menu, manipulating data related to an inventory, initiating a reporting, indicating a posting requirement, manipulating data related to an account payable, manipulating data related to an account receivable, initiating a transformation of the custom transaction data manipulation procedure, and initiating a transformation of a related transaction data manipulation procedure.

4. The computer-implemented method of claim 1, wherein storing the custom transaction data manipulation procedure in the data store further comprises storing the custom transaction data manipulation procedure in a manner that is native such that core code of the enterprise resource planning system may be updated without affecting the custom transaction data manipulation procedure.

5. The computer-implemented method of claim 1, wherein the input from the user is received through a graphical user-interface executing on a remote client computer communicatively coupled to the enterprise resource planning computing environment

6. The computer-implemented method of claim 1, wherein the input is entered at a remote client computer and the custom transaction data manipulation procedure is stored at the data store, the data store associated with a server computer that hosts the enterprise resource planning system.

7. The computer-implemented method of claim 1, further comprising making the custom transaction data manipulation procedure stored in the data store available to other users of the enterprise resource planning system.

8. The computer-implemented method of claim 1, further comprising:
invoking a custom transaction data manipulation procedure; and
updating data in a general ledger in response to invoking the custom transaction data manipulation procedure.

9. A non-transitory computer-readable medium having computer-executable instructions that when executed in a computing environment cause:
in an enterprise resource planning computing environment, maintaining a plurality of transaction data manipulation procedures in a data store, each of the plurality of transaction data manipulation procedures respectively associated with a transaction type;
receiving an input from a remote computer coupled to the enterprise resource planning computing environment, the input causing creation of a custom transaction data manipulation procedure that is different from each of the plurality of transaction data manipulation procedures, the custom transaction data manipulation procedure associated with a custom transaction type; and
storing the custom transaction data manipulation procedure in the data store.

10. The computer-readable medium of claim 9, further comprising computer-executable instructions for validating the custom transaction data manipulation procedure after creation.

11. The computer-readable medium of claim 9, further comprising executing the custom transaction data manipulation procedure through remote user instantiation, the remote user different than the user that created the custom transaction data manipulation procedure.

12. The computer-readable medium of claim 9, further comprising updating a transaction data manipulation procedure maintained in the data store while not affecting the custom transaction data manipulation procedure stored in the data store.

13. A computer-based system, comprising:
a server computer configured to execute an enterprise resource planning system, such that a plurality of users associated with a plurality of business entities may invoke one or more of a plurality of transaction data manipulation procedures that are maintained at the server computer; and
a remote client computer associated with one of the users and configured to execute an operating system for displaying a graphical user interface, the graphical user interface configured to provide input fields to a user for creating a custom transaction data manipulation procedure having a plurality of transaction parameters, the custom transaction data manipulation procedure different from each of the plurality of transaction data manipulation procedures that are maintained at the server computer;
wherein the remote client computer is further configured to store the created custom transaction data manipulation procedure in the data store with the plurality of transaction data manipulation procedures that are maintained at the server computer.

14. The computer-based system of claim 13, further comprising a general ledger maintained at the server computer and configured to be updated after invocation of the custom transaction data manipulation procedure.

15. The computer-based system of claim 13, further comprising an update module configured to update at least one transaction data manipulation procedure while maintaining the custom transaction data manipulation procedure.

16. The computer-based system of claim 13, further comprising a cloud computing environment within which the server computer and the client computer are executing.

17. The computer-based system of claim 13, wherein the plurality of transaction parameters comprise at least one from the group including: assigning a transaction number, assigning a date, assigning a creator, manipulating data in a general ledger, initiating notification to government agency, initiating notification to a manager, requesting approval from a manager, initiating printing of a form, affecting workflow of a different transaction, populating a help menu; populating a navigation menu, manipulating data related to an inventory, initiating a reporting, indicating a posting requirement, manipulating data related to an account payable, manipulating data related to an account receivable, initiating a transformation of the custom transaction data manipulation procedure, and initiating a transformation of a related transaction data manipulation procedure.

18. The computer-based system of claim 13, further comprising a validation module configured to validate the custom transaction data manipulation procedure after creation.

19. The computer-based system of claim 13, further comprising a transformation module configured to transform a transaction invoked from one of the plurality of transaction data manipulation procedures into a transaction associated with the custom transaction data manipulation procedure.

20. The computer-based system of claim 13, further comprising a credential module configured to authenticate a user of the remote computer.
